(19) United States
(12) Patent Application Publication
(10) Pub. No.: US 2022/0405983 A1
(43) Pub. Date: Dec. 22, 2022

(54) ELECTRONIC DEVICE AND METHOD FOR DISPLAYING AUGMENTED REALITY CONTENT

(71) Applicant: Samsung Electronics Co., Ltd., Suwon-si, Gyeonggi-do (KR)

(72) Inventors: Hyunjin KIM, Suwon-si, Gyeonggi-do (KR); Jaewook JUNG, Suwon-si, Gyeonggi-do (KR)

(21) Appl. No.: 17/435,614

(22) PCT Filed: Jun. 18, 2021
(86) PCT No.: PCT/KR2021/007686

§ 371 Date: Sep. 1, 2021

(30) Foreign Application Priority Data
Dec. 14, 2020 (KR) 10-2020-0174727

(51) Int. Cl. G06T 11/00; G06T 7/73; G06V 20/20

(52) U.S. Cl. CPC G06T 11/00; G06T 7/74; G06V 20/20

(57) ABSTRACT

An example method of displaying augmented reality content includes receiving, from a server, augmented reality content for a real space and pieces of first location information generated to display the augmented reality content; detecting a plurality of objects present in the real space using a detection mode to obtain pieces of object location information of the detected plurality of objects; calculating first vectors indicating differences between the pieces of first location information and the pieces of object location information; identifying, among the first vectors, second vectors for modifying the pieces of first location information; generating pieces of second location information about locations where the augmented reality content is to be displayed by modifying the pieces of first location information based on the second vectors; and displaying the augmented reality content by rendering the augmented reality content at locations corresponding to the pieces of second location information.

### TECHNICAL FIELD

The disclosure relates to a method of displaying augmented reality content, and an electronic device for displaying augmented reality content.

### BACKGROUND ART

Augmented reality refers to a technology of providing, to a user, a virtual screen providing additional information by synthesizing and combining a virtual object or thing and an image of a real world space.

A range of applications of augmented reality technology has expanded to include fields such as remote medical diagnosis, broadcasting, location-based services, mobile games, mobile solution industries, and education.

A user terminal may provide augmented reality by directly generating and rendering augmented reality content. However, there is a limit to generating augmented reality content by a user terminal due to limitations on computing performance of the user terminal and power consumption generated when the augmented reality content is rendered.

Recently, with the development of a network technology, cloud-based augmented reality technology, in which the user terminal receives and outputs augmented reality content from a high computing performance server which generates and renders the augmented reality content, has received attention. In particular, the user terminal receives, from the server, augmented reality content corresponding to location information and direction information of the user terminal, which have been transmitted to the server, and displays the augmented reality content.

However, cloud-based augmented reality technology may be unable to display the augmented reality content according to a location of an object when the object where the augmented reality content is to be displayed moves quickly or the user terminal moves quickly, due to a delay time generated as data is transmitted and received between the user terminal and the server. Accordingly, unnatural augmented reality content may be provided to the user.

### DISCLOSURE

### Technical Problem

Embodiments of the disclosure provide an electronic device for displaying augmented reality content by correcting an error of a sensor information or data transmitted from a user terminal to a server, and an error of a location where the augmented reality content is rendered, the error of the location being caused by a delay time generated as data is transmitted and received between a user terminal and a server.

The embodiments of the disclosure also provide a method of displaying augmented reality content using the electronic device.

### Technical Solution

According to an example embodiment of the disclosure, a method, performed by an electronic device, of displaying augmented reality content includes: receiving, from a server, augmented reality content for a real space and pieces of first location information generated to display the augmented reality content; detecting one or more objects present in the real space using a detection model to obtain pieces of object location information of the detected one or more objects; calculating first vectors indicating differences between the pieces of first location information and the pieces of object location information; identifying, among the first vectors, second vectors for modifying the pieces of first location information; generating pieces of second location information about locations where the augmented reality content is to be displayed by modifying the pieces of first location information based on the second vectors; and displaying the augmented reality content by rendering the augmented reality content at locations corresponding to the pieces of second location information.

According to an example embodiment of the disclosure, an electronic device for displaying augmented reality content, includes: a communication interface including communication circuitry; a memory storing a program including one or more instructions; and a processor configured to execute the one or more instructions of the program stored in the memory to: control the communication interface to receive, from a server, augmented reality content for a real space and pieces of first location information generated to display the augmented reality content; detect one or more objects present in the certain space using a detection model to obtain pieces of object location information of the detected one or more objects; calculate first vectors indicating differences between the pieces of first location information and the pieces of object location information; identify, among the first vectors, second vectors for modifying the pieces of first location information; generate pieces of second location information about locations where the augmented reality content is to be displayed by modifying the pieces of first location information based on the second vectors; and display the augmented reality content by rendering the augmented reality content at locations corresponding to the pieces of second location information.

### DESCRIPTION OF DRAWINGS

FIG. 1 is a diagram illustrating an example method, performed by an electronic device, of receiving augmented reality content from a server and modifying a location for displaying the received augmented reality content, according to various embodiments;

FIG. 2 is a block diagram illustrating an example configuration of an electronic device, according to various embodiments;

FIG. 3A is a flowchart illustrating an example method, performed by an electronic device, of modifying a location where augmented reality content is displayed and displaying the augmented reality content at the modified location, according to various embodiments;

FIG. 3B is a diagram for additionally describing the flowchart of FIG. 3A;

FIG. 4 is a diagram illustrating an example method, performed by an electronic device, of matching pieces of first location information and pieces of object information, and calculating first vectors, according to various embodiments;

FIG. 5 is a diagram illustrating an example method, performed by an electronic device, of identifying second vectors to be used to modify pieces of first location information, among first vectors, according to various embodiments;

FIG. 6A is a diagram illustrating an example method, performed by an electronic device, of identifying the first vectors, according to various embodiments;

FIG. 6B is a diagram illustrating an example method, performed by an electronic device, of identifying the outlier vectors among the first vectors, according to various embodiments;

FIG. 6C is a diagram illustrating an example method, performed by an electronic device, of modifying the pieces of first location information using the second vectors, according to various embodiments of the disclosure;

FIG. 6D is a diagram illustrating an example method, performed by an electronic device, of modifying the pieces of first location information using only the representative value of the second vectors, according to various embodiments;

FIG. 7 is a diagram illustrating an example method, performed by an electronic device, of rendering augmented reality content based on second location information and displaying the augmented reality content, according to various embodiments;

FIG. 8 is a signal flow diagram illustrating an example method, performed by a server, of generating augmented reality data, and a method, performed by an electronic device, of recognizing an object based on the augmented reality data, according to various embodiments;

FIG. 9 is a diagram illustrating an example method, performed by an electronic device, of generating second location information by modifying first location information and rendering augmented reality content based on the second location information, according to various embodiments;

FIG. 10 is a block diagram illustrating a detailed configuration of an example electronic device and server, according to various embodiments; and

FIG. 11 is a block diagram illustrating example components configuring a network environment when a server is an edge data network using an edge computing technology, according to various embodiments.

### MODE FOR INVENTION

The terms used in the specification will be briefly defined, and the disclosure will be described in detail.

Terms including descriptive or technical terms which are used herein should be construed as having meanings that are apparent to one of ordinary skill in the art. However, the terms may vary according to intentions of those of ordinary skill in the art, precedents, the emergence of new technologies, or the like. Furthermore, specific terms may be arbitrarily selected by the applicant, and in this case, the meaning of the specific terms will be described in detail in the detailed description of the disclosure. Thus, the terms used herein may be defined based on the meaning thereof and descriptions made throughout the disclosure, rather than simply on names used.

An expression used in the singular may encompass the expression in the plural, unless the context clearly indicates the term is singular. Terms used herein, including technical or scientific terms, may have the same meaning as commonly understood by one of ordinary skill in the art. Further, terms including ordinal numbers such as “first”, “second”, and the like used in the present specification may be used to describe various components, but the components should not be limited by the terms. The above terms are used only to distinguish one component from another.

Throughout the disclosure, the expression “at least one of a, b or c” indicates only a, only b, only c, both a and b, both a and c, both b and c, all of a, b, and c, or variations thereof.

When a part “includes” or “comprises” an element, unless there is a particular description to the contrary, the part may further include other elements, not excluding the other elements. In addition, terms such as “ . . . unit” and “ . . . module” used in the disclosure refer to a unit that processes at least one function or operation, which may be embodied as hardware or software, or a combination of hardware and software.

Hereinafter, various example embodiments of the disclosure will be described in greater detail with reference to the accompanying drawings. However, it should be understood that the disclosure may have different forms and is not limited to the various example embodiments set forth herein and may be embodied in different ways. Parts not related to the description of the example embodiments in the present disclosure are omitted in the drawings so that an explanation of the example embodiments of the disclosure may be clearly set forth, and like reference numerals denote like elements throughout the drawings.

According to various embodiments, first location information is location information generated by a server. The first location information may refer, for example, to information generated by the server to display augmented reality content in a screen of an electronic device. The server may obtain an image (e.g., an image of a real space) from the electronic device and generate the augmented reality content based on the obtained image. Also, while generating the augmented reality content, the server may generate first location information about a location for displaying the augmented reality content, based on one or more objects detected in the obtained image. The server may transmit, to the electronic device, the generated augmented reality content and first location information.

According to various embodiments, second location information may refer, for example, to location information generated by the electronic device. The second location information denotes information generated by the electronic device by modifying the first location information received from the server to render the augmented reality content in the screen of the electronic device. The electronic device may generate the second location information by modifying or correcting an error or the like included in the first location information, render the augmented reality content received from the server based on the second location information, and display the augmented reality content.

According to various embodiments, a first vector may refer, for example, to a vector indicating a difference between the first location information generated by the server and object location information indicating locations of objects detected by the electronic device within a real space. In other words, the first vector may be information indicating how much a location of an object in a real space is different from a location calculated by the server to display the augmented reality content on the object. The first vector may include length information and direction information.

According to various embodiments, a second vector may refer, for example, to a remaining vector obtained by excluding vectors determined to be outliers from the first vectors. In other words, the second vector may be a vector indicating how much a location of an object in a real space is different from a location calculated by the server to display the augmented reality content on the object and from which information determined to be an outlier is removed. Accordingly, the second vectors may be a subset of the first vectors. The electronic device may generate the second location information by modifying the first location information received from the server based on the second vectors, and render the augmented reality content based on the second location information.

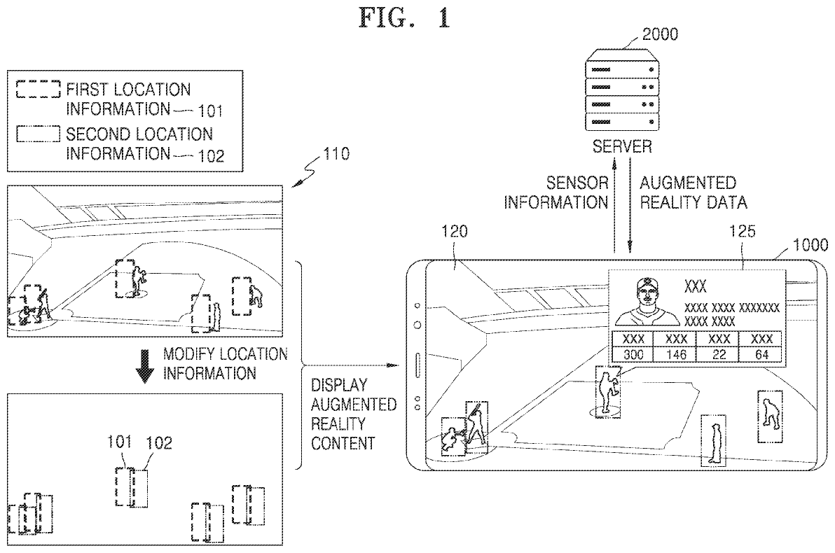

FIG. 1 is a diagram illustrating an example method, performed by an electronic device 1000, of receiving augmented reality content 125 from a server 2000 and modifying a location for displaying the received augmented reality content 125, according to various embodiments.

Referring to FIG. 1, the electronic device 1000 according to various embodiments may provide the augmented reality content 125 to a user using augmented reality data received from the server 2000. For example, the electronic device 1000 may display the augmented reality content 125 corresponding to each of at least one object on an image obtained for a certain real space including the at least one object.

According to various embodiments, the electronic device 1000 may, for example, include an operation apparatus, such as a mobile device (for example, a smartphone or a tablet personal computer (PC)) or a general-purpose computer (a PC), capable of transmitting and receiving data to and from the server 2000 via a network. Also, the electronic device 1000 may include an operation apparatus including an artificial intelligence model, such as a mobile device (for example, a smartphone or a tablet PC), or a general-purpose computer (a PC). The electronic device 1000 may receive a user input. For example, the electronic device 1000 may receive a user input for selecting a type of the augmented reality content 125 and display the augmented reality content 125 selected by the user. As another example, the electronic device 1000 may receive a user input for selecting an object and display the augmented reality content 125 corresponding to the selected object.

According to various embodiments, the server 2000 may transmit and receive data to and from the electronic device 1000. The server 2000 may receive an image and sensor information (for example, location information of the electronic device 1000 or field of view information of the electronic device 1000) from the electronic device 1000, and generate the augmented reality data related to an object included in an image obtained by the electronic device 1000. The server 2000 may transmit the generated augmented reality data to the electronic device 1000.

The augmented reality data received from the server 2000 may include the augmented reality content 125 corresponding to each of at least one object in the image, and first location information 101 about a location for displaying the augmented reality content 125, but the augmented reality data is not limited thereto.

When the augmented reality content 125 is displayed on the electronic device 1000, the augmented reality content 125 may be rendered based on the first location information 101 calculated by and received from the server 2000, and displayed on a screen of the electronic device 1000. In this case, the first location information 101 received from the server 2000 may include an error due to a delay time of the network or inaccuracy of the sensor information from the electronic device 1000. Accordingly, the augmented reality content 125 may not be displayed at an accurate location because a location of an object in the real space and a location corresponding to the first location information 101 do not accurately match in an image 110 rendered based on the first location information 101.

Accordingly, the electronic device 1000 according to various embodiments may not display the augmented reality content 125 based on the first location information 101 received from the server 2000, but may generate second location information 102 by modifying the first location information 101 to remove the error or the like included in the first location information 101, render the augmented reality content 125 based on the generated second location information 102, and display the augmented reality content 125.

For example, the electronic device 1000 according to various embodiments may detect at least one object in the real space using a detection model and obtain object location information of the detected at least one object. The electronic device 1000 may calculate first vectors indicating differences between the object location information and the first location information 101 by comparing the object location information and the first location information 101. Also, the electronic device 1000 may identify second vectors to be used to modify the first location information 101, from among the first vectors. In this case, the second vectors may be vectors obtained by excluding, from the first vectors, outlier vectors calculated as an object is detected to be at a wrong location. The electronic device 1000 may generate the second location information 102 by modifying the first location information 101 received from the server 2000, using the second vectors. The electronic device 1000 may generate an image 120 rendered based on the second location information 102, and display the augmented reality content 125.

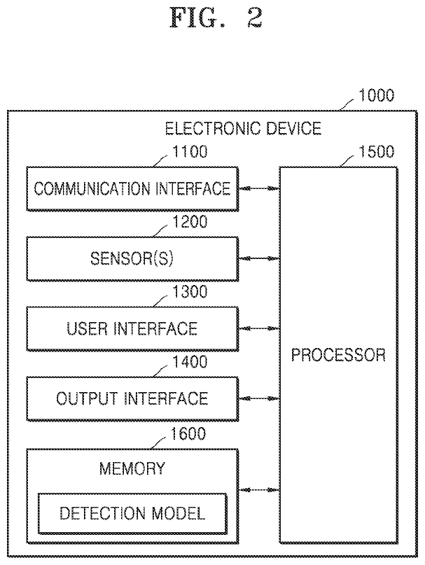

FIG. 2 is a block diagram illustrating an example configuration of the electronic device 1000, according to various embodiments.

Referring to FIG. 2, the electronic device 1000 may include a communication interface 1100, a sensor(s) 1200, a user interface 1300, an output interface 1400, a processor 1500, and a memory 1600.

The communication interface 1100 (including, for example, communication circuitry) may perform data communication with the server 2000 according to control of the processor 1500. Also, the communication interface 1100 may perform data communication with other electronic devices, in addition to the server 2000.

The communication interface 1100 may perform data communication with the server 2000 or the other electronic devices using at least one of data communication methods including, for example, wired local area network (LAN), wireless LAN, Wi-Fi, Bluetooth, ZigBee, Wi-Fi direct (WFD), infrared data association (IrDA), Bluetooth low energy (BLE), near field communication (NFC), wireless broadband Internet (Wibro), world interoperability for microwave access (WiMAX), shared wireless access protocol (SWAP), wireless gigabit alliance (WiGig), or radio frequency (RF) communication.

The communication interface 1100 according to various embodiments may transmit, to the server 2000, sensor information (for example, location information of the electronic device 1000 or field of view information of the electronic device 1000) sensed by the sensor(s) 1200 to generate augmented reality content.

According to various embodiments, the location information of the electronic device 1000 may be obtained by the electronic device 1000 using a position sensor of the electronic device 1000, such as a global positioning system (GPS) sensor. The electronic device 1000 may detect movement of the electronic device 1000 using the position sensor, and update the location information of the electronic device 1000 based on the detected movement.

According to various embodiments, the field of view information of the electronic device 1000 may be obtained by the electronic device 1000 from a gyro-sensor or the like. The electronic device 1000 may detect the movement of the electronic device 1000 using the gyro-sensor or the like, and update the field of view information of the electronic device 1000 based on the detected movement.

The sensor(s) 1200 according to various embodiments may include various sensors configured to sense information about a surrounding environment of the electronic device 1000. For example, the sensor(s) 1200 may include an image sensor (camera), an infrared sensor, an ultrasound sensor, a lidar sensor, an obstacle sensor, and the like, but the sensors are not limited to these examples.

According to various embodiments, the field of view information of the electronic device 1000 may be obtained from a field of view on an image obtained by a camera of the electronic device 1000. For example, when the electronic device 1000 obtains the field of view information via an image obtained using the camera located on a rear surface thereof, the field of view information may, for example, be information about a direction perpendicular to the rear surface of the electronic device 1000.

According to various embodiments, the field of view information of the electronic device 1000 may be obtained by comparing images obtained by the camera of the electronic device 1000.

Also, the sensor(s) 1200 according to various embodiments may obtain space structure information about a certain space using at least one of the camera, the ultrasound sensor, or the lidar sensor. The sensor(s) 1200 may obtain object image data for performing object detection, using the camera. As another example, the sensor(s) 1200 may detect the movement of the electronic device 1000 using at least one of the position sensor or the gyro-sensor, and calculate location information of the electronic device 1000 based on the detected movement.

The user interface 1300 (including, for example, user interface circuitry) according to various embodiments is a unit into which data, e.g., from a user, to control the electronic device 1000 is input. For example, the user interface 1300 may include any one or more of a key pad, a dome switch, a touch pad (contact capacitance type, pressure resistive type, an infrared (IR) detection type, surface ultrasonic wave conduction type, integral tension measuring type, piezo-effect type, or the like), a touch screen, a jog wheel, a jog switch, or the like, but the user interface is not limited to these examples.

The user interface 1300 may receive, for example, a user input to the electronic device 1000 in connection with various example embodiments.

The output interface 1400 (including, for example, output interface circuitry) according to various embodiments is for outputting an audio signal and/or a video signal, and may include a speaker, a display, or the like, but the output interface is not limited to these example components.

The speaker of the output interface 1400 may output, for example, audio data received from the communication interface 1100 or stored in the memory 1600. Also, the output interface 1400 may output a sound signal related to a function performed by the electronic device 1000.

The display of the output interface 1400 may display, for example, information processed by the electronic device 1000. For example, the display may display rendered augmented reality content on objects in a real space, or display a user interface (UI) or graphical user interface (GUI) related to the augmented reality content.

The processor 1500 (including, for example, processor circuitry) according to various embodiments may control overall operations of the electronic device 1000. The processor 1500 may execute one or more instructions of a program stored in the memory 1600. The processor 1500 may include a hardware component performing arithmetic operations, logic operations, input/output operations, and signal processing.

The processor 1500 may include at least one of, for example, a central processing unit (CPU), a micro-processor, a graphics processing unit (GPU), an application specific integrated circuit (ASIC), a digital signal processor (DSP), a digital signal processing device (DSPD), a programmable logic device (PLD), a field programmable gate array (FPGA), an application processor (AP), a neural processing unit, or an artificial intelligence-dedicated processor designed in a hardware structure specialized for processing of an artificial intelligence model, but the processor is not limited to these example components.

Detection models executed by the processor 1500 may be downloaded to the electronic device 1000 from an external source and stored in the memory 1600 of the electronic device 1000. The detection models stored in the memory 1600 may be updated.

The processor 1500 according to various embodiments may load and execute the detection model stored in the memory 1600 to detect objects in a space and obtain location information of the object. Also, the processor 1500 may generate second location information for newly rendering augmented reality content by comparing obtained object information with first location information about a location for displaying the augmented reality content received from a server.

The memory 1600 may include, for example, a non-volatile memory including at least one of a flash memory, a hard disk, a multimedia card micro type memory, a card type memory (for example, a secure digital (SD) or extreme digital (XD) memory), read-only memory (ROM), electrically erasable programmable read-only memory (EEPROM), programmable read-only memory (PROM), a magnetic memory, a magnetic disk, or an optical disk, and/or a volatile memory, such as a random access memory (RAM) or a static random access memory (SRAM).

The memory 1600 may, for example, store instructions, data structures, and program code, which may be read by the processor 1500. According to various embodiments, operations performed by the processor 1500 may be implemented by executing program instructions or code stored in the memory 1600.

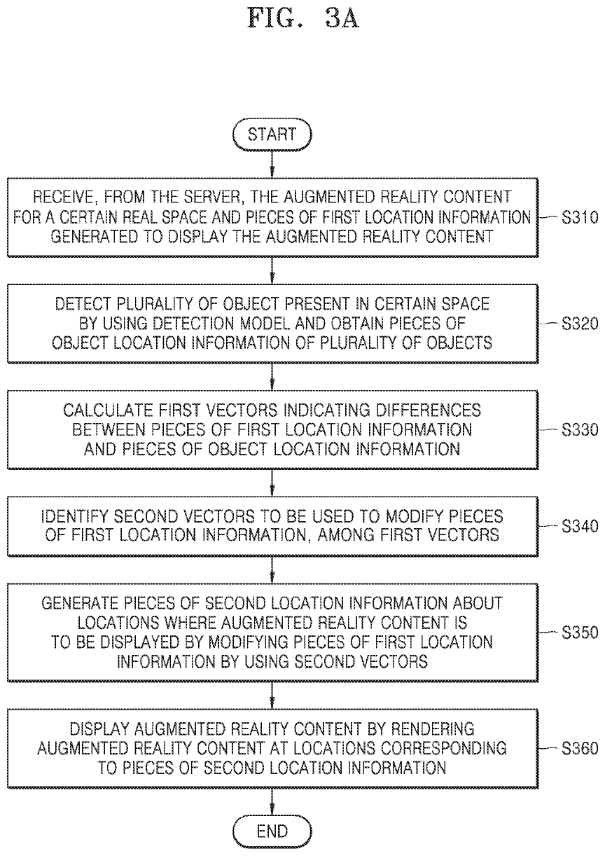

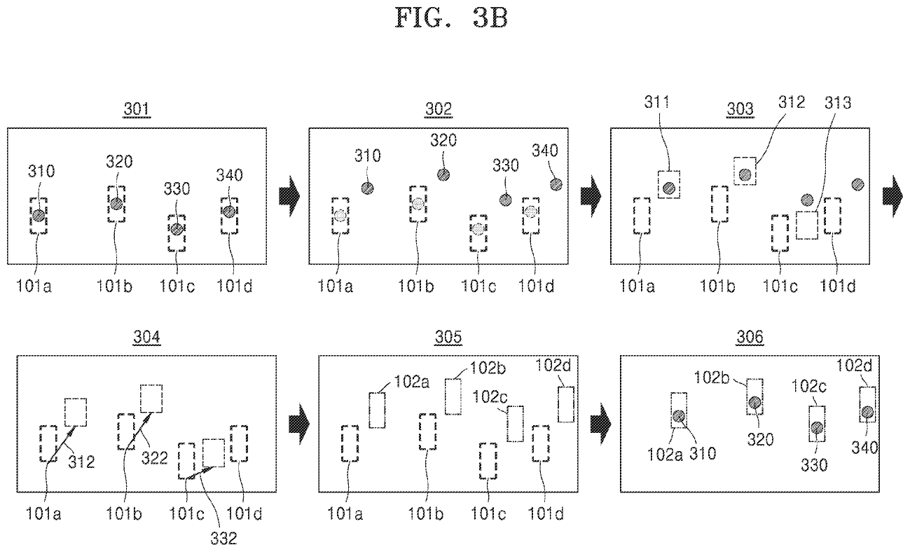

FIG. 3A is a flowchart illustrating an example method, performed by an electronic device 1000, of modifying a location where augmented reality content is displayed and displaying the augmented reality content at the modified location, according to various embodiments.

In operation S310, the electronic device 1000 may receive, from the server 2000, the augmented reality content for a certain real space and pieces of first location information generated to display the augmented reality content.

In this case, the augmented reality content and the pieces of first location information received from the server 2000 may be generated by the server 2000 based on an image of the certain space, location information of the electronic device 1000, and field of view information of the electronic device 1000, which are received from the electronic device 1000.

The pieces of first location information may, for example, be pieces of location information for displaying the augmented reality content, which correspond to objects detected by the server 2000 within the image of the certain space.

Also, the server 2000 may receive the image of the certain space from the electronic device 1000, detect the objects in the image, and generate the augmented reality content of the detected objects. In this case, when the augmented reality content is generated, the location information and field of view information of the electronic device 1000 received from the electronic device 1000 may be further used such that an identified location of the electronic device 1000 and a direction faced by the electronic device 1000 are reflected by the augmented reality content.

The electronic device 1000 according to various embodiments may modify the pieces of first location information (generated by the server to display the augmented reality content) before displaying the received augmented reality content.

In operation S320, the electronic device 1000 according to various embodiments may detect at least one object present in the certain space using a detection model and obtain pieces of object location information of the detected objects.

The electronic device 1000 may detect the objects in the image of the certain space using the detection model and obtain object classification information indicating classifications of the objects and pieces of object location information indicating locations of the objects. Alternatively, the electronic device 1000 may obtain only the object location information using the detection model.

The detection model provided in the electronic device 1000 according to various embodiments may be a lightweight detection model having detection accuracy lower than a detection model provided in the server 2000 but a higher detection speed than that provided in the server 2000. Accordingly, the electronic device 1000 may quickly obtain the object location information within the processing computing capability of the electronic device 1000 using the detection model.

In operation S330, the electronic device 1000 according to various embodiments may calculate first vectors indicating differences between the pieces of first location information and the pieces of object location information. According to various embodiments, the pieces of first location information and the pieces of object location information may include data in a form of coordinates corresponding to a display screen of the electronic device 1000.

The electronic device 1000 according to various embodiments may match the pieces of first location information and the pieces of object location information. In this case, any one of various matching algorithms may be applied to a method of matching the pieces of first location information and the pieces of object location information. The matching algorithm may be, for example, a minimum cost maximum flow (MCMF) algorithm, a Hungarian algorithm, or the like, but the matching algorithms are not limited to these examples.

The electronic device 1000 may calculate the first vectors indicating the differences between the pieces of object location information and the pieces of first location information by, for example, calculating the differences between the pieces of object location information and the pieces of first location information based on a result of matching each piece of the object location information and each piece of the first location information.

An object that is actually present in the certain space may not be detected by the electronic device 1000 as a result of detecting, by the electronic device 1000, the at least one object present in the certain space (an undetected case). In this case, because object location information of the undetected object is not obtained, first location information corresponding to the undetected object may not be matched. Accordingly, because there is no matching result value, a first vector may not be calculated for the undetected object. The undetected case will be described below with reference to FIG. 3B.

In operation S340, the electronic device 1000 according to various embodiments may identify second vectors to be used to modify the pieces of first location information, among the first vectors.

For example, inaccurate object location information may be obtained because an object is detected at a location other than an actual location, as a result of detecting, by the electronic device 1000, the at least one object present in the certain space (a mis-detected case). In this case, because the obtained object location information is inaccurate object location information, a value of the first vector indicating the difference between the object location information and the first location information may also be inaccurate. Accordingly, the electronic device 1000 may identify, as the second vectors, remaining values obtained by excluding inaccurate values from the first vectors, and use the identified second vectors to modify the pieces of first location information.

According to various embodiments, the electronic device 1000 may apply an outlier detection algorithm to the first vectors to identify the second vectors. The outlier detection algorithm may include, for example, a k-nearest neighbors (kNN) algorithm, a local outlier factor (LOF) algorithm, or the like, but the outlier detection algorithms are not limited to these examples. The electronic device 1000 may identify outlier vectors classified as outliers from the first vectors by performing the outlier detection algorithm, and identify, as the second vectors, the remaining vectors obtained by excluding the outlier vectors from the first vectors.

In operation S350, the electronic device 1000 according to various embodiments may generate pieces of second location information about locations where augmented reality content is to be displayed on the display of electronic device 1000 by modifying the pieces of first location information using the second vectors.

For example, when the object location information matching the first location information among the pieces of first location information is present and the first vector indicating the difference between the first location information and the matched object location information is identified as the second vector, the electronic device 1000 may generate the second location information by modifying the first location information using the second vector corresponding to the first location information.

Also, when the object location information matching the first location information among the pieces of first location information is present and the first vector indicating the difference between the first location information and the matched object location information is not identified as the second vector, the electronic device 1000 may generate the second location information by modifying the first location information by a representative value of the all second vectors.

Also, when the object location information matching the first location information among the pieces of first location information is not present, the electronic device 1000 may generate the second location information by modifying the first location information by the representative value of the all second vectors.

As another example, the electronic device 1000 may generate the second location information by modifying each of the pieces of first location information by the representative value of the second vectors for all pieces of first location information.

Also, when generating the pieces of second location information by modifying the pieces of first location information using the above-described methods, the electronic device 1000 may generate the pieces of second location information by further using sensor information obtained from sensors of the electronic device 1000. For example, the electronic device 1000 may obtain or calculate a moving direction, a moving speed, and a field of view direction, which are pieces of information about movement information of the electronic device 1000, using operation sensors (for example, a gyro-sensor) of the electronic device 1000, and generate the pieces of second location information on which the movement information is reflected by further using the moving direction, the moving speed, and/or the field of view direction of the electronic device 1000 while generating the pieces of second location information.

A detailed method by which the electronic device 1000 generates the pieces of second location information will be further described with reference to FIG. 3B.

In operation S360, the electronic device 1000 according to various embodiments may display the augmented reality content at a modified location by rendering the augmented reality content at locations corresponding to the pieces of second location information.

FIG. 3B is a diagram for additionally describing the flowchart of FIG. 3A.

Referring to a block 301 of FIG. 3B, a first object 310, a second object 320, a third object 330, and a fourth object 340 may be present in a certain space. The server 2000 may generate pieces of first location information 101a, 101b, 101c, and 101d for the first, second, third, and fourth objects (310, 320, 330, and 340) indicating locations for displaying augmented reality content corresponding to each of the first, second, third, and fourth objects 310, 320, 330, and 340, and transmit the pieces of first location information 101a, 101b, 101c, and 101d to the electronic device 1000.

According to various embodiments, the pieces of first location information 101a, 101b, 101, c, and 101d indicating the locations for displaying the augmented reality content may be the first location information 101a for the first object 310, the first location information 101b for the second object 320, the first location information 101c for the third object 330, and the first location information 101d for the fourth object 340.

However, referring to a block 302 of FIG. 3B, locations where the first through fourth objects 310 through 340 are actually located in the certain space may be different from the block 301. For example, there may be an error in the pieces of first location information 101a through 101d generated by the server 2000 due to an error in sensor information transmitted from the electronic device 1000 to the server 2000. As another example, there may be an error in the pieces of first location information 101a through 101d generated by the server 2000 because the locations of the first through fourth objects 310 through 340 are not updated in real-time in the server 2000 due to a network delay when movement occurs in the electronic device 1000.

A block 303 of FIG. 3B corresponds to operation S320 of FIG. 3A. Referring to the block 303 of FIG. 3B, the electronic device 1000 may detect the first through fourth objects 310 through 340 using a detection model, and obtain pieces of object location information 311, 312, and 313 indicating locations of objects. For example, the electronic device 1000 may obtain the object location information 311 indicating the location of the first object 310, the object location information 321 indicating the location of the second object 320, and the object location information 331 indicating the location of the third object 330. Here, the object location information 331 indicating the location of the third object 330 may be location information obtained by incorrectly detecting a portion in an image other than the third object 330 as an object, due to an error of the detection model or the like. Also, the fourth object 340 may not be detected by the electronic device 1000 despite the fourth object 340 being actually present in the certain space, due to an error of the detection model or the like.

A block 304 of FIG. 3B corresponds to operations S330 and S340 of FIG. 3A. Referring to the block 304 of FIG. 3B, the electronic device 1000 according to various embodiments may calculate first vectors 312, 322, and 332 indicating differences between the pieces of first location information 101a through 101d and the pieces of object location information 311, 321, and 331.

For example, the electronic device 1000 may calculate the first vector 312 corresponding to the first object 310 by calculating the difference between the first location information 101a of the first object 310 and the object location information 311 indicating the location of the first object 310.

As another example, the electronic device 1000 may calculate the first vector 322 corresponding to the second object 320 by calculating the difference between the first location information 101b of the second object 320 and the object location information 321 indicating the location of the second object 320.

As another example, the electronic device 1000 may calculate the first vector 332 corresponding to the third object 330 by calculating the difference between the first location information 101c of the third object 330 and the object location information 331 indicating the location of the third object 330.

As another example, because the fourth object 340 is not detected by the electronic device 1000, there is no object location information indicating a location of the fourth object 340, and thus a first vector corresponding to the fourth object 340 may not be calculated.

The electronic device 1000 according to various embodiments may identify second vectors to be used to modify the pieces of first location information 101a, 101b, 101c, and 101d, among the calculated first vectors 312, 322, and 332.

For example, the electronic device 1000 may identify outlier vectors by applying an outlier detection algorithm to the first vectors 312, 322, and 332. For example, because the object location information 331 indicating the location of the third object 330 is obtained by wrongly detecting a portion in the image other than the third object 330 as an object due to an error of the detection model or the like, the first vector 332 corresponding to the third object 330 may be identified as an outlier vector. In this case, the electronic device 1000 may identify, as the second vectors, the remaining first vectors 312 and 322 obtained by excluding the first vector 332 corresponding to the third object 330, first vector 332 being identified as the outlier vector from the first vectors 312, 322, and 332.

A block 305 of FIG. 3B corresponds to operation S350 of FIG. 3A. The electronic device 1000 according to various embodiments may generate pieces of second location information 102a, 102b, 102c, and 102d about locations where the augmented reality content is to be displayed on the display of the electronic device 1000, by modifying the pieces of first location information 101a through 101d using the second vectors.

For example, because the first vector 312 corresponding to the first object 310 is identified as a second vector, the electronic device 1000 may generate the second location information 102a corresponding to the first object 310 by modifying the first location information 101a about the first object 310 using the identified second vector 312.

Also, because the first vector 322 corresponding to the second object 320 is identified as a second vector, the electronic device 1000 may generate the second location information 102b corresponding to the second object 320 by modifying the first location information 101b about the second object 320 using the identified second vector 322.

Also, because the first vector 332 corresponding to the third object 330 is not identified as the second vector, the electronic device 1000 may generate the second location information 102c corresponding to the third object 330 by modifying the first location information 101c about the third object 330 using a representative value of the second vectors.

Also, because a first vector corresponding to the fourth object 340 is not present, the electronic device 1000 may generate the second location information 102d corresponding to the fourth object 340 by modifying the first location information 101d about the fourth object 340 by a representative value of the second vectors.

A block 306 of FIG. 3B corresponds to operation S360 of FIG. 3A. The electronic device 1000 according to various embodiments may display the augmented reality content at modified locations where the first through fourth objects 310, 320, 330, and 340 are actually present, by rendering the augmented reality content received from the server 2000 at locations corresponding to the generated pieces of second location information 102a, 102b, 102c, and 102d.

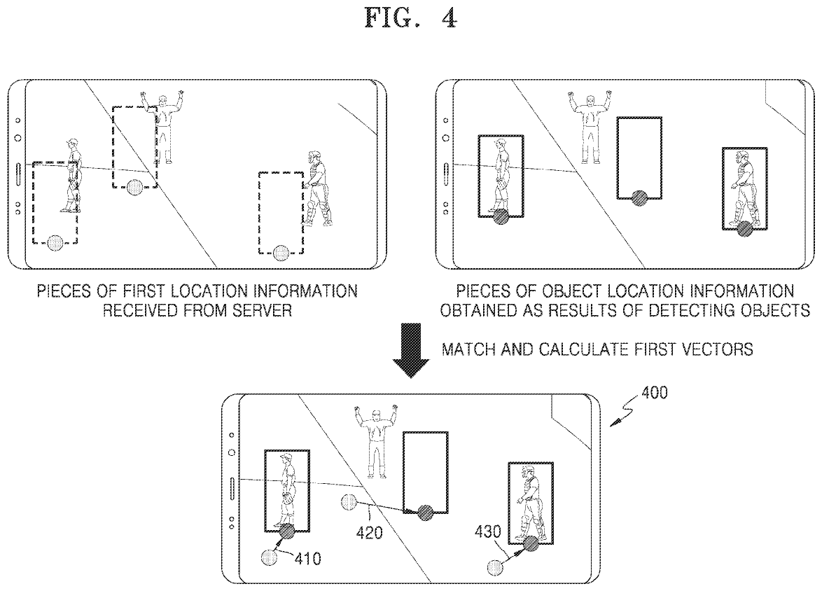

FIG. 4 is a diagram illustrating an example method, performed by the electronic device 1000, of matching pieces of first location information and pieces of object information, and calculating first vectors 410, 420, and 430, according to various embodiments.

For convenience of description, various embodiments will be described based on an example in which a certain space is a baseball field and objects to be recognized in the certain space are baseball players. However, this is only an example and the certain space and the objects are not limited thereto.

Referring to FIG. 4, the electronic device 1000 according to various embodiments may match the pieces of first location information received from the server 2000 and the pieces of object location information obtained by the electronic device 1000 using a detection model.

Locations corresponding to the pieces of first location information received from the server 2000 may be different from locations at which the objects are actually located in the certain space. For example, there may be an error in the pieces of first location information generated by the server 2000 due to an error in sensor information transmitted from the electronic device 1000 to the server 2000. As another example, there may be an error in the pieces of first location information generated by the server 2000 because the locations of the objects in the certain space are not updated in real-time in the server 2000 due to a network delay when movement occurs in the electronic device 1000.

Also, some of the pieces of object location information obtained by the electronic device 1000 using the detection model may be location information obtained by incorrectly detecting as an object a portion of the certain space other than an actual object present in the certain space.

The electronic device 1000 according to various embodiments may match the pieces of first location information received from the server 2000 and the pieces of object location information obtained as a result of detecting the objects. The electronic device 1000 may, for example, set reference points at a location corresponding to the first location information and a location corresponding to the object location information, and match the set reference points. For example, the reference point may be data in a form of coordinates. In this case, the electronic device 1000 may set a bottom of a bounding box corresponding to the first location information in an image as the reference point and set a bottom of a bounding box corresponding to the object location information in the image as the reference point to match the set reference points. However, the reference points are not limited thereto and the electronic device 1000 may set other coordinates in the bounding box as the reference points to match the first location information and the object location information.

Any one of various matching algorithms may be applied to a method by which the electronic device 1000 according to various embodiments matches the pieces of first location information and the pieces of object location information. The matching algorithm may be, for example, a Minimum Cost Maximum Flow (MCMF) algorithm, a Hungarian algorithm, or the like, but the matching algorithm is not limited to these example matching algorithms.

A block 400 of FIG. 4 shows results of matching the pieces of first location information and the objects, and the first vectors 410, 420, and 430 calculated based on the results of matching.

The electronic device 1000 according to various embodiments may calculate the first vectors 410, 420, and 430 based on the results of matching. For example, the first vectors 410, 420, and 430 corresponding to the results of matching may be calculated by calculating differences between the reference points of the pieces of object location information and the reference points of the pieces of first location information, with respect to the results of matching the pieces of object location information and the pieces of first location information. In this case, the first vectors 410, 420, and 430 may be vectors indicating distances and directions from locations corresponding to the pieces of first location information to locations corresponding to the pieces of object location information. The electronic device 1000 may identify second vectors to be used to modify the pieces of first location information, from among the calculated first vectors 410, 420, and 430.

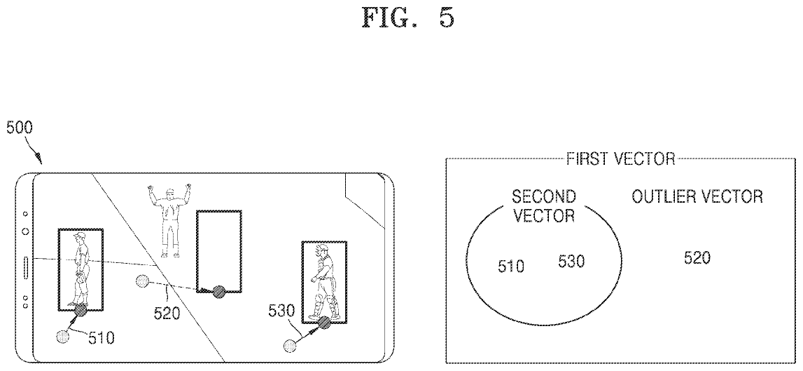

FIG. 5 is a diagram illustrating an example method, performed by the electronic device 1000, of identifying second vectors to be used to modify pieces of first location information, among first vectors 510, 520, and 530, according to various embodiments.

The electronic device 1000 according to various embodiments may identify, among the first vectors 510, 520, and 530, the second vectors for generating pieces of second location information obtained by modifying the pieces of first location information, to render augmented reality content at an accurate location.

A block 500 of FIG. 5 shows the calculated first vectors 510, 520, and 530. The electronic device 1000 according to various embodiments may generate a list of the first vectors 510, 520, and 530 by gathering the calculated first vectors 510, 520, and 530.

Referring to FIG. 5, the electronic device 1000 according to various embodiments may detect outlier vectors among the calculated first vectors 510, 520, and 530. For convenience of description, the first vectors 510, 520, and 530 will be respectively referred to as a first vector “a” 510, a first vector “b” 520, and a first vector “c” 530. For example, the electronic device 1000 may apply an outlier detection algorithm on the calculated first vectors 510, 520, and 530. The outlier detection algorithm may include, for example, a k-nearest neighbors (kNN) algorithm, a local outlier factor (LOF) algorithm, or the like, but the outlier detection algorithm is not limited to these example algorithms.

The first vector “b” 520 may be identified as an outlier vector among the first vectors 510, 520, and 530, as a result of detecting outlier vectors among the first vectors 510, 520, and 530. In this case, the electronic device 1000 may identify, as the second vectors, the first vector “a” 510 and the first vector “c” 530, which are remaining first vectors obtained by excluding the first vector “b” 520 identified as the outlier vector.

The electronic device 1000 may generate the pieces of second location information about locations where the augmented reality content is to be displayed, using the identified second vectors.

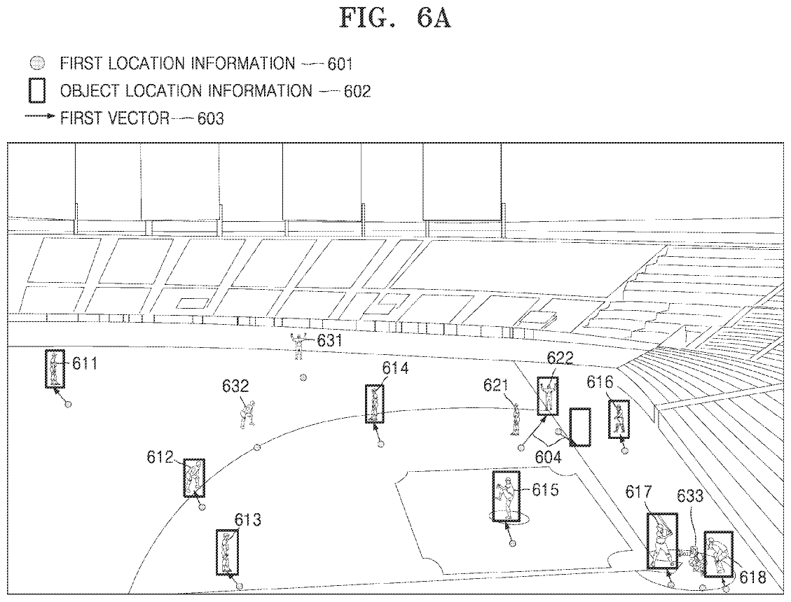

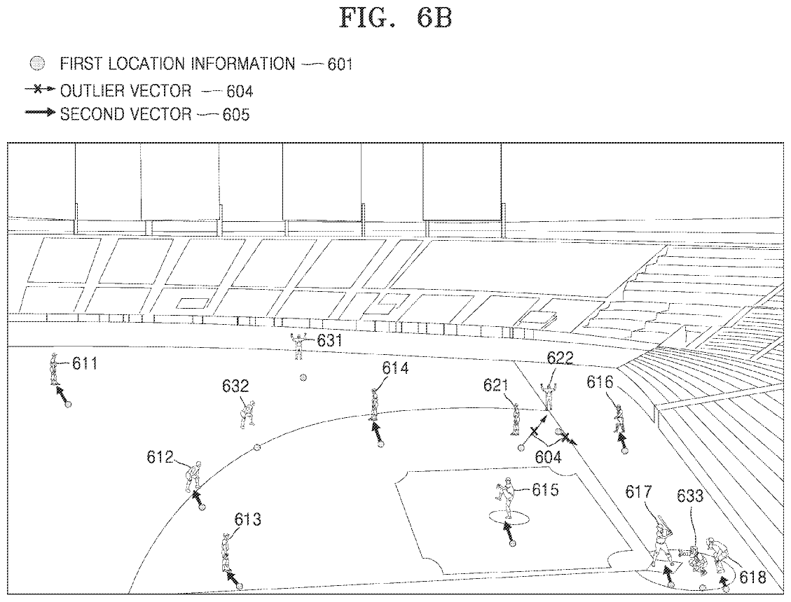

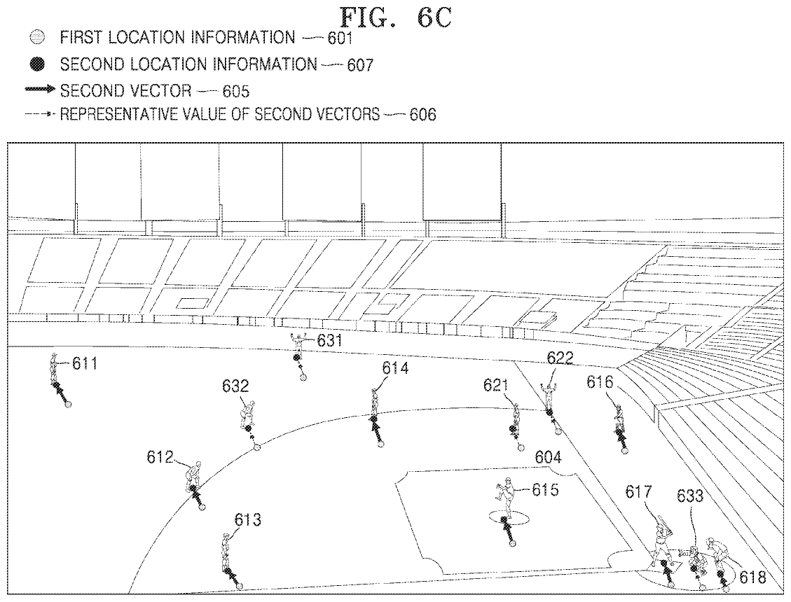

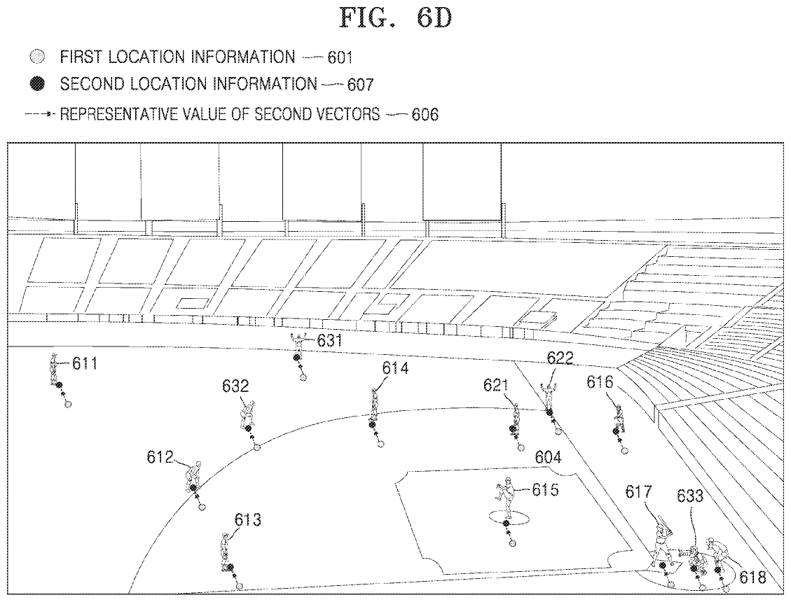

FIG. 6A is a diagram illustrating an example method, performed by an electronic device 1000, of identifying the first vectors 603, according to various embodiments.

Referring to FIG. 6A, the electronic device 1000 according to various embodiments may receive pieces of first location information 601 from the server 2000, obtain pieces of object location information 602 by detecting a plurality of objects in a certain space using a detection model, and identify the first vectors 603 by comparing the pieces of first location information 601 and the pieces of object location information 602.

For convenience of description, the plurality of objects will be respectively referred to as first through eighth objects 611, 612, 613, 614, 615, 616, 617, and 618, ninth and tenth objects 621 and 622, and eleventh through thirteenth objects 631, 632, and 633.

According to various embodiments, the pieces of first location information 601 may refer, for example, to pieces of location information calculated by and received from the server 2000 and indicating locations for displaying augmented reality content with respect to the first through thirteenth objects 611-618, 621, 622, and 631-633.

The detection model provided in the electronic device 1000 according to various embodiments may be a lightweight detection model relative to a detection model provided in the server 2000. In this case, all objects present in the certain space may not be accurately detected.

For example, the pieces of object location information 602 obtained with respect to the first through eighth objects 611-618 may be pieces of accurate object location information obtained as objects are accurately detected. However, the pieces of object location information 602 obtained with respect to the ninth and tenth objects 621 and 622 may be pieces of inaccurate object location information obtained as objects are inaccurately detected (a mis-detected case). Also, pieces of object location information may not be obtained with respect to the eleventh through thirteenth objects 631, 632, and 633 because the eleventh through thirteenth objects 631, 632, and 633 are not detected (an undetected case).

However, the electronic device 1000 is unable to determine whether the obtained pieces of object location information 602 are accurate or inaccurate only based on the obtained pieces of object location information 602. Accordingly, the electronic device 1000 may match the obtained pieces of object location information 602 and the pieces of first location information 601 regardless of whether the obtained pieces of object location information 602 are accurate, and calculate the first vectors 603 by calculating differences between the matched pieces. In this case, because pieces of object location information are not obtained with respect to the eleventh through thirteenth objects 631 through 633, there are no pieces of object location information matched to the pieces of first location information 601, and thus first vectors are not calculated.

FIG. 6B is a diagram illustrating an example method, performed by an electronic device 1000, of identifying the outlier vectors 604 among the first vectors 603, according to various embodiments. Referring to FIG. 6B, the electronic device 1000 according to various embodiments may identify outlier vectors 604 among the first vectors 603 to distinguish a first vector calculated from inaccurate object location information.

For example, an image frame for generating the pieces of first location information 601 by the server 2000 and an image frame for obtaining the pieces of object location information 602 by the electronic device 1000 may be a same image frame or adjacent image frames within a certain number of frames. Accordingly, movement degrees of objects within a short interval in the certain number of frames may be similar and may not be large. Thus, at this time, the first vectors 603 calculated from the ninth and tenth objects 621 and 622, which are mis-detected objects, may be detected as the outlier vectors 604.

The electronic device 1000 may identify, as the second vectors 605, remaining vectors obtained by excluding vectors detected as the outlier vectors 604 from the first vectors 603. In this case, according to various embodiments, the first vectors 603 calculated from the first through eighth objects 611 through 618 are identified as the second vectors 605.

FIG. 6C is a diagram illustrating an example method, performed by an electronic device 1000, of modifying the pieces of first location information 601 using the second vectors 605, according to various embodiments. Referring to FIG. 6C, according to various embodiments, the electronic device 1000 may modify the pieces of first location information 601 using the second vectors 605.

For example, the electronic device 1000 may generate the pieces of second location information 607 obtained by modifying the pieces of first location information 601 based on the second vectors 605 corresponding to the pieces of first location information 601, with respect to the first through eighth objects 611 through 618 where the identified second vectors 605 are present. Also, with respect to the ninth and tenth objects 621 and 622 where the identified second vectors 605 are not present and the first vectors 603 are identified as the outlier vectors 604, the electronic device 1000 may generate the pieces of second location information 607 by moving the pieces of first location information 601 based on a representative value 606 of the second vectors 605. Also, with respect to the eleventh through thirteenth objects 631 through 633 where the first vectors 603 are not present, the electronic device 1000 may generate the pieces of second location information 607 by moving the pieces of first location information 601 based on the representative value 606 of the second vectors 605.

The representative value 606 of the second vectors 605 may be obtained using the second vectors 605. For example, the representative value 606 may be an average value, an intermediate value, or the like of the second vectors 605, but the representative value is not limited to these examples.

The electronic device 1000 according to various embodiments may generate the pieces of second location information 607 by modifying the pieces of first location information 601 as described above.

FIG. 6D is a diagram illustrating an example method, performed by an electronic device 1000, of modifying the pieces of first location 601 information using the representative value 606 of the second vectors 605, according to various embodiments. Referring to FIG. 6D, according to various embodiments, the electronic device 1000 may modify the pieces of first location information 601 using the representative value 606 of the second vectors 605. For example, the electronic device 1000 may generate the pieces of second location information 607 by modifying the pieces of first location information 601 based on the representative value 606, with respect to all objects present in the certain space. The representative value 606 may be an average value, an intermediate value, or the like of the second vectors 605, but the representative value is not limited to these examples.

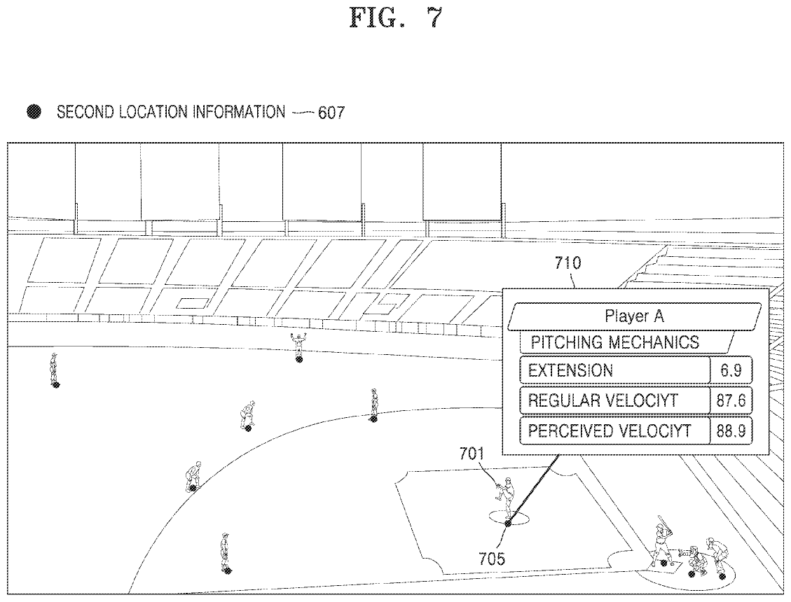

FIG. 7 is a diagram illustrating an example method, performed by the electronic device 1000, of rendering augmented reality content based on second location information and displaying the augmented reality content, according to various embodiments.

The electronic device 1000 according to various embodiments may modify pieces of first location information received from the server 2000 to generate pieces of second location information about locations for rendering augmented reality content for objects in a space, as described with reference to FIGS. 6A, 6B, 6C, and 6D. The electronic device 1000 may render the pieces of augmented reality content at the locations corresponding to the pieces of second location information, based on the generated pieces of second location information.

For example, the electronic device 1000 may have recognized a player A 701 as an object. The electronic device 1000 may render augmented reality content 710 for the player A 701 based on second location information 705 corresponding to the player A 701, and display the augmented reality content 710.

In the same manner, the electronic device 1000 may render the augmented reality content corresponding to each of the objects present in the space and display the augmented reality content, based on the generated pieces of second location information with respect to the objects.

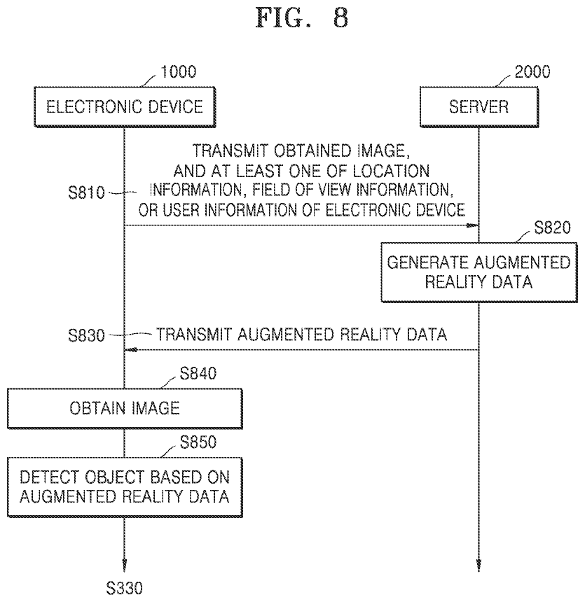

FIG. 8 is a signal flow diagram illustrating a method, performed by the server 2000, of generating augmented reality data, and a method, performed by the electronic device 1000, of recognizing an object based on the augmented reality data, according to various embodiments.

Referring to FIG. 8, in operation S810, the electronic device 1000 may transmit, to the server 2000, obtained image and at least one of location information of the electronic device 1000, field of view information of the electronic device 1000, or user information of the electronic device 1000. For example, the electronic device 1000 may transmit, to the server 2000, the location information and field of view information of the electronic device 1000 in a real space, such as a stadium, a venue, an exhibition hall, or a shopping mall. As another example, the electronic device 1000 may transmit, to the server 2000, user information (for example, a gender, an age, a job, and an interest).

In operation S820, the electronic device 1000 may detect an object using a detection model and generate augmented reality data for the image received from the electronic device 1000. According to various embodiments, at least one of the location information, field of view information, or user information of the electronic device 1000 may be further used. However, the example embodiments are not limited thereto, and other information may be used to generate the augmented reality data. The augmented reality data may include augmented reality content for an object, a location for displaying the augmented reality content, and the like.

For example, the server 2000 may generate the augmented reality content based on the location information and field of view information of the electronic device 1000. According to various embodiments, when it is determined that the electronic device 1000 is located in a baseball field and the field of view information indicates a ground in the baseball field, baseball players in the baseball field may be detected from the received image and the augmented reality content of the baseball players may be generated.

Also, the server 2000 may generate the augmented reality content based on user information of the electronic device 1000. For example, when a baseball game is played between an A team and a B team, and a user of the electronic device 1000 is a fan of the A team, the server 2000 may generate the augmented reality content based on content (for example, cheer content for the A team) recommended to fans of the A team while generating the augmented reality content for the baseball players.

Also, the server 2000 may generate pieces of first location information indicating locations for displaying the generated augmented reality content on a screen of the electronic device 1000.

In operation S830, the server 2000 transmits to the electronic device 1000 the augmented reality data including the augmented reality content and the first location information.

In operation S840, the electronic device 1000 may obtain an image. Here, the image may be obtained using a camera included in the electronic device 1000. The image obtained in operation S840 may be an image of a same frame as the image described in operation S810, an image of a next frame of the image described in operation S810, or an image after a certain number of frames from the image described in operation S810.

In operation S850, the electronic device 1000 may detect objects in the image obtained in operation S840, based on the augmented reality data.

According to various embodiments, when detecting the objects in the image obtained in operation S840, the electronic device 1000 may detect the objects based on the pieces of first location information included in the augmented reality data. For example, to reduce throughput, the electronic device 1000 may detect the objects by first searching locations corresponding to the pieces of first location information and surrounding locations thereof in the obtained image.

Also, when detecting the objects in the image obtained in operation S840, the electronic device 1000 may detect the objects based on the augmented reality content included in the augmented reality data. For example, when the augmented reality content is about the baseball players, the electronic device 1000 may detect the objects using a detection model suitable for detecting baseball players.

After operation S850, the electronic device 1000 may generate pieces of second location information by modifying the pieces of first location information included in the augmented reality data. Also, the electronic device 1000 may render the augmented reality content based on the pieces of second location information, and display the augmented reality content. These operations correspond to operations S330 through S360 of FIG. 3, and thus descriptions thereof are not repeated here.

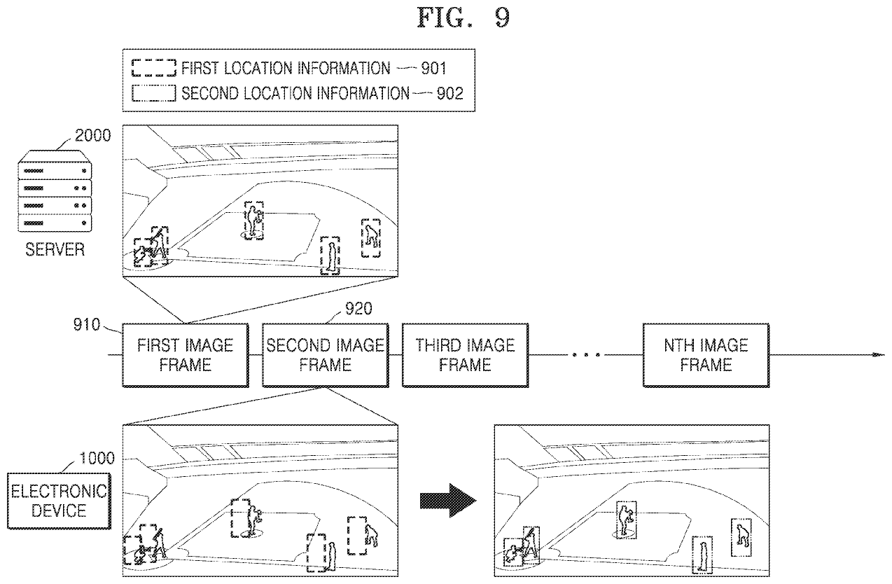

FIG. 9 is a diagram illustrating an example method, performed by the electronic device 1000, of generating second location information 902 by modifying first location information 901 and rendering augmented reality content based on the second location information 902, according to various embodiments.

The electronic device 1000 according to various embodiments may receive, from the server 2000, the first location information 901 generated to display the augmented reality content. In this case, the pieces of first location information 901 generated to display the augmented reality content may have been generated based on a first image frame 910.

Accordingly, when the electronic device 1000 according to various embodiments is to display the augmented reality content by rendering the augmented reality content on a second image frame 920, the image frame currently displayed in the electronic device 1000 may be the second image frame 920, while the received pieces of first location information 901 may be location information generated based on the first image frame 910, due to a delay in data transmission and reception between the electronic device 1000 and the server 2000.

In this case, the electronic device 1000 may obtain pieces of object location information by detecting objects in the second image frame 920 according to the example embodiments described above, generate the pieces of second location information 902, render the augmented reality content at locations corresponding to the pieces of second location information 902, and display the augmented reality content.

Also, according to various embodiments, when generating the pieces of second location information 902 to modify the locations where the augmented reality content is rendered, the electronic device 1000 may detect objects in frames based on certain frame intervals instead of all frames to reduce the throughput, and obtain the pieces of object location information of the detected objects.

For example, the electronic device 1000 may detect the objects in the frames for each Kth frame based on certain frame intervals K, and obtain the pieces of object location information of the detected objects. For example, when the electronic device 1000 generated the second location information 902 with respect to the second image frame 920 and modified the location where the augmented reality content is rendered, the electronic device 1000 may perform operations of generating the pieces of second location information 902 according to the example embodiments described above, every Kth frame after the second image frame 920.

The electronic device 1000 according to various embodiments may match the pieces of first location information 901 received last from the server 2000 with the pieces of object location information obtained every Kth frame, and calculate first vectors indicating differences between the pieces of object location information and the pieces of first location information. Also, the electronic device 1000 may identify second vectors to be used to modify the pieces of first location information, from among the calculated first vectors, and generate the pieces of second location information 902 about locations where the augmented reality content is to be displayed, using the second vectors.

Also, when the electronic device 1000 according to various embodiments obtains the pieces of object location information present in the frames based on the certain frame intervals K and generates the pieces of second location information 902 according to the example embodiments described above, the certain frame intervals K may be determined based on a delay time of the data transmission and reception between the electronic device 1000 and the server 2000.

For example, when the electronic device 1000 generates the pieces of second location information 902 every current certain frame interval K and the delay time of the data transmission and reception between the electronic device 1000 and the second location information is greater than the present delay time of the data transmission and reception, an error of the location where the augmented reality content is rendered in the electronic device 1000 may become greater. Accordingly, the electronic device 1000 may determine the certain frame intervals to have a value smaller than K. For example, the electronic device 1000 may determine the certain frame intervals to be J, wherein J<K, such that the pieces of second location information 902 are generated more frequently.

Also, when the delay time of data transmission and reception between the electronic device 1000 and the server 2000 is less than the present delay time of the data transmission and reception, the error of the location where the augmented reality content is rendered in the electronic device 1000 may become smaller. Accordingly, the electronic device 1000 may determine the certain frame intervals to be a value greater than K. For example, the electronic device 1000 may determine the certain frame intervals to be L, wherein L>K, such that the pieces of second location information 902 are generated less frequently.

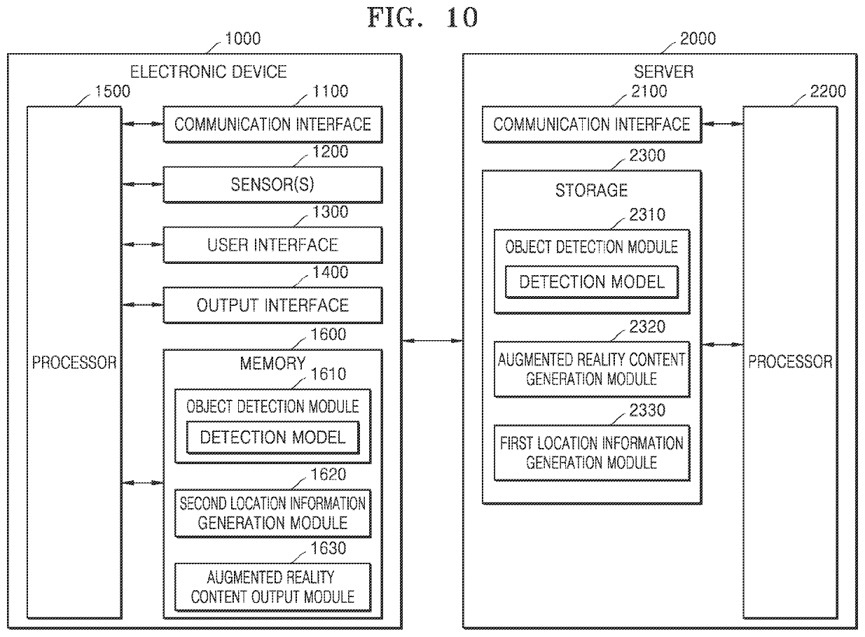

FIG. 10 is a block diagram illustrating detailed example configurations of the electronic device 1000 and server 2000, according to various embodiments.

Referring to FIG. 10, the electronic device 1000 may include the communication interface 1100, the sensor(s) 1200, the user interface 1300, the output interface 1400, the processor 1500, and the memory 1600. Because the communication interface 1100, the sensor(s) 1200, the user interface 1300, the output interface 1400, and the processor 1500 have been described with reference to FIG. 2, descriptions thereof are not repeated here.

The memory 1600 according to various embodiments may store data and program instruction code corresponding to an object detection module 1610, a second location information generation module 1620, and an augmented reality content output module 1630. However, the disclosure is not limited to the modules, and the electronic device 1000 may provide augmented reality content to a user using more or less software modules than those shown in FIG. 10.

According to various embodiments, the processor 1500 may obtain object classification information indicating types of objects and object location information indicating locations of the objects by detecting the objects in a certain space, using the data and instruction code related to the object detection module 1610. Also, there may be a plurality of detection models included in the object detection module 1610. In this case, the processor 1500 may determine a suitable detection model based on location information of the electronic device 1000, and perform object detection. For example, when the location information of the electronic device 1000 indicates a baseball field, the electronic device 1000 may perform the object detection using a detection model suitable for detecting objects (for example, baseball players) in the baseball field. As another example, when the location information of the electronic device 1000 indicates a shopping mall, the electronic device 1000 may perform the object detection using a detection model suitable for detecting objects (for example, shopping items) in the shopping mall.

According to various embodiments, the processor 1500 may generate second location information by modifying first location information, using the data and instruction code related to the second location information generation module 1620. The processor 1500 may render the augmented reality content based on the generated second location information. The processor 1500 may identify vectors indicating differences between the pieces of object location information and the pieces of first location information by comparing the pieces of object location information obtained as results of detecting the objects and the pieces of first location information received from the server 2000 and indicating the locations where the augmented reality content is rendered, and generate the pieces of second location information used by the processor 1500 to render the augmented reality content at locations corresponding to accurate locations of the objects, based on the identified vectors.

According to various embodiments, the processor 1500 may output the augmented reality content using the data and instruction code related to the augmented reality content output module 1630. The processor 1500 may render the augmented reality content received from the server 2000 on the image based on the generated pieces of second location information, and display the augmented reality content.

The server 2000 may include a communication interface 2100, a processor 2200, and a storage 2300.

The communication interface 2100 (including, for example, communication circuitry) may perform data communication with the electronic device 1000 according to control of the processor 2200.

The communication interface 2100 may perform data communication with the electronic device 1000 using at least one of data communication methods including, for example, wired LAN, wireless LAN, Wi-Fi, Bluetooth, ZigBee, WFD, IrDA, BLE, NFC, Wibro, WiMAX, SWAP, WiGig, and RF communication.

The communication interface 2100 according to various embodiments may receive, from the electronic device 1000, sensor information (for example, location information of the electronic device 1000 or field of view information of the electronic device 1000) and the image to generate the augmented reality content, and transmit the generated augmented reality content to the electronic device 1000.

The processor 2200 (including, for example, processor circuitry) may execute one or more instructions of a program stored in the storage 2300. The processor 2200 may include a hardware component performing arithmetic operations, logic operations, input/output operations, and signal processing.

The processor 2200 may be configured of at least one of, for example, a central processing unit (CPU), a micro-processor, a graphic processing unit (GPU), application specific integrated circuits (ASICs), digital signal processors (DSPs), digital signal processing devices (DSPDs), programmable logic devices (PLDs), field programmable gate arrays (FPGAs), an application processor (AP), a neural processing unit (NPU), or an artificial intelligence-dedicated processor designed in a hardware structure specialized for processing of an artificial intelligence model, but the processor is not limited to these components.

The processor 2200 according to various embodiments may detect objects in the received image and generate the augmented reality content related to the detected objects. Also, the processor 2200 may generate the pieces of first location information indicating the locations for displaying the generated augmented reality content.

The storage 2300 may include, for example, a non-volatile memory including at least one of a flash memory, a hard disk, a multimedia card micro type memory, a card type memory (for example, Secure Digital (SD) memory, eXtreme Digital (XD) memory, or the like), read-only memory (ROM), electrically erasable programmable read-only memory (EEPROM), programmable read-only memory (PROM), a magnetic memory, a magnetic disk, or an optical disk, and/or a volatile memory, such as random access memory (RAM) or static random access memory (SRAM).

The storage 2300 may store instructions, data structures, and program code, which may be read by the processor 2200. According to various embodiments, operations performed by the processor 2200 may be implemented by executing program instructions or codes stored in the storage 2300.

The storage 2300 may store data and program instruction code corresponding to an object detection module 2310, an augmented reality content generation module 2320, and a first location information generation module 2330.

According to various embodiments, the processor 2200 may detect types and locations of the objects in the image using the data and instruction code related to the object detection module 2310. Also, there may be a plurality of detection models included in the object detection module 2310. When there are the plurality of detection models, the server 2000 may determine a suitable detection model based on location information of the electronic device 1000, and perform object detection.

According to various embodiments, the processor 2200 may generate the augmented reality content of the detected objects using the data and instruction code related to the augmented reality content generation module 2320.

According to various embodiments, the processor 2200 may generate the pieces of first location information using the first location information generation module 2330, wherein the pieces of first location information are used such that the generated augmented reality content is displayed at locations corresponding to locations of the detected objects. The processor 2200 may transmit the generated pieces of first location information and the generated augmented reality content to the electronic device 1000 using the communication interface 2100.

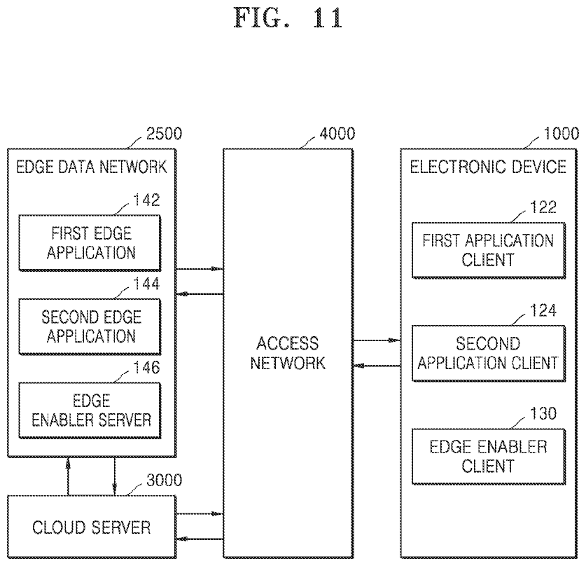

Meanwhile, the server 2000 of FIG. 10 may be an edge data network using a multi-access edge computing (MEC) technology. This will be described additionally with reference to FIG. 11.

FIG. 11 is a block diagram illustrating example components configuring a network environment when the server 2000 is an edge data network using an edge computing technology, according to various embodiments.

Edge edge computing technology may include, for example, multi-access edge computing (MEC) or fog computing (FOC). Edge edge computing technology may refer, for example, to a technology of providing data to an electronic device via a separate server (hereinafter, an edge data network or an MEC server) provided at a location geographically close to the electronic device, for example, inside a base station or near the base station.

For example, an application requiring a low delay time (latency) among at least one application provided in the electronic device may transmit or receive data via an edge server provided at a geographically close location without passing through a server located in an external data network (DN) (for example, the Internet). For convenience of description, FIG. 11 will be described based on an edge data network using an MEC technology. However, the disclosure is not limited to an edge data network using MEC technology.

Referring to FIG. 11, the network environment according to various embodiments may include the electronic device 1000, the edge data network 2500, a cloud server 3000, and an access network (AN) 4000. However, the network environment is not limited to the components illustrated in FIG. 11.

According to various embodiments, each of the components included in the network environment may denote a physical entity unit or denote a software or module unit capable of performing an individual function.

According to various embodiments, the electronic device 1000 may denote an apparatus used by a user. For example, the electronic device 1000 may be a terminal, a user equipment (UE), a mobile station, a subscriber station, a remote terminal, a wireless terminal, or a user device.

Also, the electronic device 1000 may be an electronic device providing augmented reality content according to various embodiments of the present disclosure.

Referring to FIG. 11, the electronic device 1000 may include a first application client (or an application client) 122, a second application client 124, and an edge enabler client (or an MEC enabling layer (MEL)) 130. The electronic device 1000 may perform a necessary task using the edge enabler client 130 so as to use an MEC service. For example, the edge enabler client 130 may be used to search for an application and provide required data to the application.

According to various embodiments, the electronic device 1000 may execute a plurality of applications. For example, the electronic device 1000 may execute the first application client 122 and the second application client 124. A plurality of applications may require different network services based on at least one of a required data rate, a delay time (or speed) (latency), reliability, the number of electronic devices accessing a network, a network accessing cycle of the electronic device 1000, or average data usage. The different network services may include, for example, enhanced mobile broadband (eMBB), ultra-reliable and low latency communication (URLLC), or massive machine type communication (mMTC).

An application client of the electronic device 1000 may denote a basic application pre-installed in the electronic device 1000 or an application provided by a third party. In other words, the application client may denote a client application program driven in the electronic device 1000 for a particular application service. Several application clients may be driven in the electronic device 1000. At least one of the application clients may use a service provided from the edge data network 2500. For example, the application client is an application installed in and executed by the electronic device 1000, and may provide a function of transmitting or receiving data through the edge data network 2500. The application client of the electronic device 1000 may denote application software executed on the electronic device 1000 to use a function provided by at least one particular edge application.

According to various embodiments, the first and second application clients 122 and 124 of the electronic device 1000 may perform data transmission with the cloud server 3000 based on a required network service type or perform edge computing-based data transmission with the edge data network 2500. For example, when the first application client 122 does not require low latency, the first application client 122 may perform data transmission with the cloud server 3000. As another example, when the second application client 124 requires low latency, the second application client 124 may perform MEC-based data transmission with the edge data network 2500.

According to various embodiments, the AN 4000 may provide a channel for wireless communication with the electronic device 1000. For example, the AN 4000 may denote a radio access network (RAN), a base station, an eNodeB (eNB), a 5th generation (5G) node, a transmission/reception point (TRP), or a 5th generation nodeB (SGNB).

According to various embodiments, the edge data network 2500 may denote a server accessed by the electronic device 1000 to use the MEC service. The edge data network 2500 may be provided at a location geographically close to the electronic device 1000, for example, inside a base station or near a base station.

According to various embodiments, the edge data network 2500 may transmit or receive data to or from the electronic device 1000 without passing through the external DN (for example, the Internet). According to various embodiments, MEC may stand for multi-access edge computing or mobile-edge computing.

According to various embodiments, the edge data network 2500 may be referred to as an MEC host, an edge computing server, a mobile edge host, an edge computing platform, or an MEC server.

Referring to FIG. 11, the edge data network 2500 may include a first edge application 142, a second edge application 144, and an edge enabler server (or an MEC platform (MEP)) 146. The edge enabler server 146 performs traffic control and/or provides an MEC service to the edge data network 2500, and may provide, to the edge enabler client 130, application-related information (for example, application availability/enablement).

According to various embodiments, the edge data network 2500 may execute a plurality of applications. For example, the edge data network 2500 may execute the first edge application 142 and the second edge application 144.

According to various embodiments, an edge application may denote an application provided by a third party in the edge data network 2500 providing an MEC service and may be referred to as an edge application. The edge application may be used to form a data session with an application client so as to transmit or receive data related to the application client. In other words, the edge application may form the data session with the application client.

According to various embodiments, the data session may denote a communication path formed such that an application client of the electronic device 1000 and an edge application of the edge data network 2500 transmit or receive data.

According to various embodiments, the application of the edge data network 2500 may be referred to as an MEC application (MEC app), an edge application server, or an edge application. For convenience of description, hereinafter, the application of the edge data network 2500 is referred to as an edge application in the present disclosure. Here, the edge application may denote an application server present in the edge data network 2500.

According to various embodiments, the cloud server 3000 may provide application-related content. For example, the cloud server 3000 may be managed by a content business operator. According to various embodiments, the cloud server 3000 may transmit or receive data to or from the electronic device 1000 through the external DN (for example, the Internet).

Although not shown in FIG. 11, a core network (CN) and a DN may be present between the AN 4000 and the edge data network 2500.

According to various embodiments, the DN may provide a service (for example, an Internet service or an IP multimedia subsystem (IMS) service) by transmitting or receiving data (or a data packet) to or from the electronic device 1000 through the CN and the AN 4000. For example, the DN may be managed by a communication business operator. According to various embodiments, the edge data network 2000 may be connected to the AN 4000 or the CN through a DN (for example, a local DN).

According to various embodiments, when the electronic device 1000 executes the first application client 122 or the second application client 124, the electronic device 1000 may access the edge data network 2000 through the AN 4000 to transmit or receive data for executing an application client.

Meanwhile, the block diagrams of the electronic device 1000 and server 2000 of FIGS. 2 and 10 are block diagrams according to various embodiments of the present disclosure. Components of the block diagram may be integrated, a component may be added, or a component may be omitted according to the specification of each device that is actually implemented. In other words, two or more components may be integrated into one component or one component may be divided into two or more components when necessary or desirable. Also, a function performed by each block is only for describing non-limiting example embodiments of the disclosure and specific operations or apparatuses do not limit the scope of the disclosure.

A method, performed by an electronic device, of displaying augmented reality content, according to various embodiments, may be recorded on a computer-readable recording medium (e.g., a non-transitory computer-readable recording medium) by being implemented in a form of program commands executed using various computers. The computer-readable recording medium may include at least one of a program command, a data file, or a data structure. The program commands recorded in the computer-readable recording medium may be specially designed or well known to one of ordinary skill in the computer software field. Examples of the computer-readable recording medium include magnetic media such as hard disks, floppy disks, and magnetic tapes, optical media such as CD-ROMs and DVDs, magneto-optical media such as floptical disks, and hardware devices specially configured to store and perform program commands, such as read-only memory (ROM), random-access memory (RAM), and flash memory. Examples of the computer commands include mechanical code prepared by a compiler, and high-level languages executable by a computer using an interpreter.

Furthermore, the method, performed by the electronic device, of displaying augmented reality content, according to various embodiments, may be provided by being included in a computer program product. Computer program products are products that can, for example, be traded between sellers and buyers.

The computer program product may include a software program or a computer-readable storage medium storing a software program. For example, the computer program product may include a product (for example, a downloadable application) in a form of a software program that is electronically distributable through a manufacturer of the electronic device or an electronic market (for example, Google PlayStore™ or AppStore™). For electronic distribution, at least a part of the software program may be stored in the storage medium or temporarily generated. In this case, the storage medium may be a storage medium of a server of a manufacturer, a server of an electronic market, or a relay server that temporarily stores the software program.

The computer program product may include a storage medium of a server or a storage medium of an electronic device in a system including the server and the electronic device. Alternatively, when there is a third device, e.g., a smartphone, that communicates with the server or the electronic device, the computer program product may include a storage medium of the third device. Alternatively, the computer program product may include the software program transmitted from the server to the electronic device or the third device, or transmitted from the third device to the electronic device.

In this case, one of the server, the electronic device, and the third device may perform a method according to various embodiments of the present disclosure by executing the computer program product. Alternatively, two or more of the server, the electronic device, and the third device may execute the computer program product to perform the method according to various embodiments of the present disclosure in a distributed fashion.

While the embodiments of the disclosure have been particularly shown and described in detail, it will be understood by one of ordinary skill in the art that various changes in form and details may be made therein without departing from the true spirit and full scope of the disclosure as defined by the following claims.

1. A method, performed by an electronic device, of displaying augmented reality content, the method comprising:
receiving, from a server, augmented reality content for a real space and pieces of first location information generated to display the augmented reality content;
detecting a plurality of objects present in the real space using a detection model to obtain pieces of object location information of the detected plurality of objects;
calculating first vectors indicating differences between the pieces of first location information and the pieces of object location information;
identifying, among the first vectors, second vectors for modifying the pieces of first location information;
generating pieces of second location information about locations where the augmented reality content is to be displayed by modifying the pieces of first location information based on the second vectors; and
displaying the augmented reality content by rendering the augmented reality content at locations corresponding to the pieces of second location information.

2. The method of claim 1, wherein the calculating of the first vectors comprises:
matching the pieces of object location information and the pieces of first location information; and
calculating, as the first vectors, vectors indicating distances and directions from locations corresponding to the pieces of first location information to locations corresponding to the pieces of object location information, for the pieces of first location information matched to the pieces of object location information.

3. The method of claim 2, wherein the identifying of the second vectors comprises:
identifying outlier vectors indicating an outlier among the first vectors; and
identifying, as the second vectors, remaining vectors obtained by excluding the outlier vectors from the first vectors.

4. The method of claim 3, wherein the generating of the pieces of second location information comprises:
modifying, based on the second vectors, the pieces of first location information where the second vectors are identified, from among the pieces of first location information matched to the pieces of object location information;
modifying, using a representative value of the second vectors, the pieces of first location information where the outlier vectors are identified, from among the pieces of first location information matched to the pieces of object location information; and
modifying, using the representative value of the second vectors, pieces of first location information not matched to the pieces of object location information.

5. The method of claim 4, wherein the representative value of the second vectors is an average value of the second vectors.

6. The method of claim 1, further comprising:
transmitting, to the server, location information and field of view information of the electronic device,
wherein the receiving, from the server, of the augmented reality content and the pieces of first location information comprises:
receiving, from the server, the pieces of first location information and the augmented reality content generated by the server based on the location information of the electronic device and the field of view information of the electronic device.

7. The method of claim 6, wherein the detecting of the plurality of objects present in the real space comprises:
detecting the plurality of objects based on the pieces of first location information; and
obtaining the pieces of object location information of the plurality of objects.

8. The method of claim 1, wherein the generating of the pieces of second location information comprises:
generating the pieces of second location information by further using sensor information obtained from sensors of the electronic device.

9. The method of claim 1, wherein the detecting of the plurality of objects present in the real space comprises:
detecting the plurality of objects present in the real space using the detection model based on a certain frame interval, and the obtaining of the pieces of object location information of the plurality of objects.

10. The method of claim 9, wherein the certain frame interval is determined based on a delay time of data transmission and reception between the electronic device and the server.

11. An electronic device comprising:
a communication interface configured to perform data communication with a server;
a memory storing a program including one or more instructions; and
a processor configured to execute the one or more instructions of the program stored in the memory to:
control the communication interface to receive, from the server, augmented reality content for a real space and pieces of first location information generated to display the augmented reality content;
detect a plurality of objects present in the real space using a detection model to obtain pieces of object location information of the detected plurality of objects;
calculate first vectors indicating differences between the pieces of first location information and the pieces of object location information;
identify, among the first vectors, second vectors to be used to modify the pieces of first location information;
generate pieces of second location information about locations where the augmented reality content is to be displayed by modifying the pieces of first location information based on the second vectors; and
control the display to display the augmented reality content by rendering the augmented reality content at locations corresponding to the pieces of second location information.

12. The electronic device of claim 11, wherein the processor is further configured to:
match the pieces of object location information and the pieces of first location information; and
calculate, as the first vectors, vectors indicating distances and directions from locations corresponding to the pieces of first location information to locations corresponding to the pieces of object location information, for the pieces of first location information matched to the pieces of object location information.

13. The electronic device of claim 12, wherein the processor is further configured to:
identify outlier vectors indicating an outlier among the first vectors; and
identify, as the second vectors, remaining vectors obtained by excluding the outlier vectors from the first vectors.

14. The electronic device of claim 13, wherein the processor is further configured to:
modify, based on the second vectors, the pieces of first location information where the second vectors are identified, from among the pieces of first location information matched to the pieces of object location information;
modify, using a representative value of the second vectors, the pieces of first location information where the outlier vectors are identified, from among the pieces of first location information matched to the pieces of object location information; and
modify, using the representative value of the second vectors, pieces of first location information not matched to the pieces of object location information.

15. The electronic device of claim 11, wherein the processor is further configured to:
control the communication interface to transmit, to the server, location information and field of view information of the electronic device; and
control the communication interface to receive, from the server, the pieces of first location information and the augmented reality content generated by the server based on the location information of the electronic device and the field of view information of the electronic device.

16. The electronic device of claim 15, wherein the processor is further configured to detect the plurality of objects based on the pieces of first location information, and obtain the pieces of object location information of the plurality of objects.

17. The electronic device of claim 11, wherein the processor is further configured to generate the pieces of second location information by further using sensor information obtained from sensors of the electronic device.

18. The electronic device of claim 11, wherein the processor is further configured to detect the plurality of objects present in the real space using the detection model based on a certain frame interval, and obtain of the pieces of object location information of the plurality of objects.

19. The electronic device of claim 18, wherein the certain frame interval is determined based on a delay time of data transmission and reception between the electronic device and the server.

20. A non-transitory computer-readable recording medium having recorded thereon a program for executing the method of claim 1 on a computer.
